(19) United States
(12) Patent Application Publication
(10) Pub. No.: US 2005/0125151 A1
(43) Pub. Date: Jun. 9, 2005

(54) Global real-time transmission and control system in safety for aircraft by a/v and digital data and salvaging system

(75) Inventor: Chien-Shing Lee, Taoyuan Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: Space-Tek., Co., Ltd., Taoyuan Hsien (TW)

(21) Appl. No.: 10/500,498

(22) PCT Filed: Apr. 8, 2002
(86) PCT No.: PCT/IB02/01326

(30) Foreign Application Priority Data
Dec. 31, 2001 (TW) 090133079

(51) Int. Cl. G01S 1/00; G01C 21/00

(52) U.S. Cl. 701/213; 701/3; 342/357.07

(57) ABSTRACT

A global real-time transmission and control system, which can track the position of the aircraft by up-linking and down-linking the A/V information and can control the A/V devices equipped on the aircraft. The automatic tracking system includes an aircraft A/V transmitting system disposed on the aircraft, an A/V automatic tracking system at ground for the aircraft, and a ground control system. The automatic tracking system is used to receive information from the aircraft A/V transmitting system, and automatically transmit the received information to the ground control system. According to the actual need, the ground control system can actively obtain the A/V information by the video/camera unit through the aircraft A/V transmitting system and the A/V automatic tracking system. Additionally, a salvaging plane is provided to land on the aircraft, which needs a salvage due to an accident or hijacking occurring on the aircraft.

### BACKGROUND OF THE INVENTION

1. Field of Invention

The present invention relates to an aircraft tracking technology and the salvaging technology. More particularly, the present invention relates to a global real-time transmission and control system in safety and a salvaging system for an aircraft by audio/video (A/V) and digital data.

2. Description of Related Art

In the current daily life, aircraft has been well known by people as a tool for public transportation, aerial reconnaissance, and so on. The aircraft can be any type of aerobus, cargo-airplane, or even fighters in military use. As the communication technology has also been well developed, it allows the aircraft to have communication equipment to communicate with a ground control system. Also and, the ground control system can also manage the aircraft.

When the aircraft flies in the sky to perform a duty, such as transporting passengers from one place to another place, or a duty to scout the ground surface, the communication measure is a wireless measure to transmit signals. Usually, the pilot should report his information, such as surface position and height, to the ground control system for tracking the location of the aircraft and the flight route. However, if the pilot fails to report his correct location due to, for example, absent mind, it then results in many errors, and further may cause an air accident. Or, the aircraft may loose contact due to some emergent events. In this situation, the location of the aircraft or what happens on the aircraft cannot be known.

As the wireless telecommunication technology is further developed, technologies of global positioning system (GPS) or likewise GLONASS have been successfully developed. If the aircraft carries the sensing device for the GPS or GLONASS, the location of the aircraft with respect to the ground surface could be automatically detected and would be sent to the ground control system. However, from the view point of the whole operation system, it so far has no automatic tracking system with full function for the aircraft.

Additionally, the current design of equipment on the aircraft cannot also transmit the A/V and digital data to the ground control system, in which for the current status only the audio signal can be transmitted. Particularly, the ground control system cannot directly control the aircraft, to obtain the desired video information.

Especially, when an emergent event or even a hijacking occur on the aircraft on flight, the ground control system cannot actively control the video equipment on the aircraft to handle the actual situation on the aircraft.

For the conventional communication system, it still has no automatic tracking system for the aircraft with full function for tracking and monitoring uses, to efficiently track the flight route and obtain the actual scene which has happened.

Furthermore, when the aircraft flies away from the land area or has been beyond the radar detecting area, the location and the situation had occurred of the aircraft cannot be detected in active manner.

### SUMMARY OF THE INVENTION

The invention provides a global real-time transmission and control system of an A/V and digital information, and can be instantly down-link for the A/V and digital information of the actual scene of damage to the ground control system. Also and, the invention can be used in environmental protection, transportation, coast cruise, and so on, so as to, in real-time, transmit the A/V and digital information down to the ground control system. Moreover, it can also be used to capture the 3-D scene at the battle field for military events, and the system can be activated when an emergent event or hijacking occur on a commercial aerobus. Furthermore, it can be used in photo-reconnaissance and the related with the ground control system to setup an automatic tracking system for aircraft.

The invention provides a global real-time transmission and control system of an A/V and digital information, which can track the position of the aircraft by up-linking and down-linking the A/V information and can control the A/V devices equipped on the aircraft. This automatic tracking system includes an aircraft A/V transmitting system installed on the aircraft, an A/V automatic tracking system on ground for the aircraft, and a ground control system. The aircraft A/V transmitting system includes a global positioning unit, a height positioning unit, a video/camera unit, an A/V information and digital information down-link unit, a bi-directional digital signal unit, and a microprocessing unit. The A/V automatic tracking system is used to receive information from the A/V and digital down-link unit and the bi-directional digital signal unit, and automatically transmit the received information to the ground control system. According to the actual need for the situation, the ground control system can actively obtain the A/V information by the video/camera unit through the aircraft A/V transmitting system and the ground control system.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is system diagram, schematically illustrating a global real-time transmission and control system of an A/V and digital information, according to a preferred embodiment of the invention;

FIG. 2 is function block diagram, schematically illustrating an aircraft A/V and digital information transmitting system, according to a preferred embodiment of the invention;

FIG. 3 is function block diagram, schematically illustrating an aircraft automatic tracking and A/V system, according to a preferred embodiment of the invention;

FIG. 4 is function block diagram, schematically illustrating a central control station system, according to a preferred embodiment of the invention;

FIG. 5 is a drawing, schematically illustrating a global tracking mechanism for the global real-time transmission and control system of an A/V and digital information, according to a preferred embodiment of the invention;

FIG. 6 is a drawing, schematically illustrating a salvaging system, according to a preferred embodiment of the invention; and

FIG. 7 is a drawing, schematically illustrating the structure on the aircraft with respect to the salvaging system.

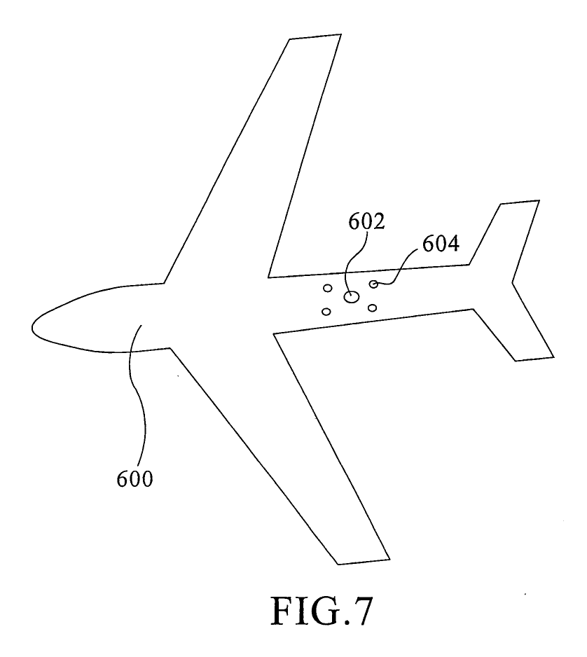

### DESCRIPTION OF THE PREFERRED EMBODIMENTS

In the invention, a global real-time transmission and control system of an A/V and digital information and a salvaging system are provided, so as to automatically track an aircraft in a bi-directional manner and actively obtain the audio/video (A/V) and digital data. The A/V and digital data can include, for example, the video, audio, or digital data of 3-dimensional position of the aircraft. The digital data can also include any data information in other types. The use of video, audio, and digital data in alone or combination is optional in the invention. The ground control system can actively select and turn on one or multiple video/camera devices on the aircraft, so as to actively obtain the A/V information, and to observe what occurs inside the aircraft inside or the situation outside of the aircraft. For example, a geology structure of the ground surface is taken during reconnaissance. The invention has the function of up-link for control and function of down-link for A/V and digital data.

In the salvaging system of the invention, a communication system can be installed on a rescuing aircraft so as to transport salvaging rescuer or any desired matter and then solve the problem occurs on the aircraft.

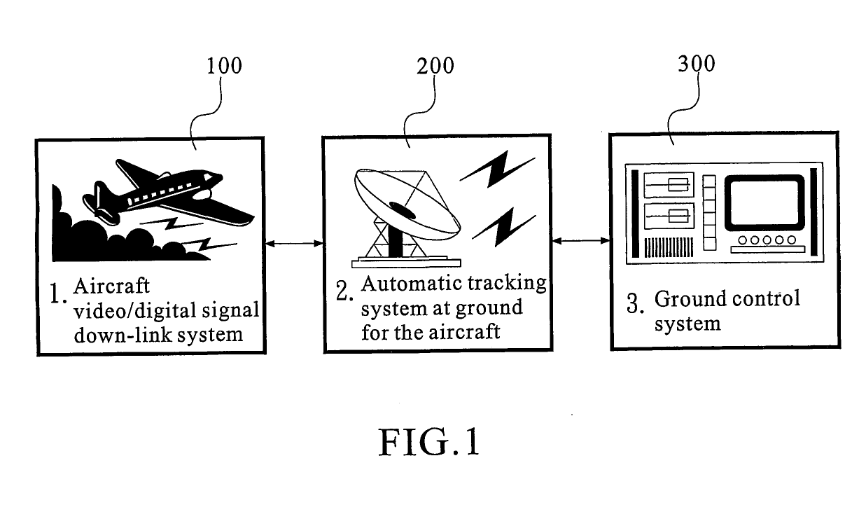

The global real-time transmission and control system of an A/V and digital information of the invention includes three subsystems. FIG. 1 is system diagram, schematically illustrating a global real-time transmission and control system of an A/V and digital information, according to a preferred embodiment of the invention, which includes an aircraft A/V and digital information transmitting system 100, an aircraft automatic tracking and A/V system 200, and a central control station system 300. The invention is suitable for use at ground to track an aircraft flying in the sky in real-time. A 3-dimentional position of the aircraft can be automatically detected, also and the A/V information can be obtained by video/camera device. The central control station system can also send an A/V control signal to turn on the video/camera device for monitoring the actual situation within the shot range.

In FIG. 1, the aircraft A/V and digital information transmitting system 100 is installed on an aircraft, used to detect an A/V and digital information, including a 3-dimensional position data, an audio data, a video data, and so on. In addition, the A/V and digital information is transmitted out, and an A/V control signal transmitted from the central control station can be received, whereby it can dynamically capture the A/V and digital information as desired.

Moreover, the aircraft automatic tracking and A/V system 200 can be installed, for example, on a ground base (not shown) for receiving the down-link information of A/V and digital data. The antenna device can automatically track the 3-dimension position data of the aircraft. Also and, the A/V and digital data or any relevant data can be transmitted out.

The central control station system 300, such as a central control station, receives the A/V and digital information sent from the aircraft automatic tracking and A/V system and can transmit an A/V control signal through the aircraft automatic tracking and A/V system to dynamically control the aircraft A/V and digital information transmitting system to obtain the desired A/V and digital information.

In the foregoing subsystems, the aircraft automatic tracking and A/V system and the central control station system can also be installed on a movable vehicle. For example, they can be integrated into a movable system installed on a car, ship, or another rescuing aircraft serving for control or rescue.

These three subsystems 100, 200, and 300 are further described in the following.

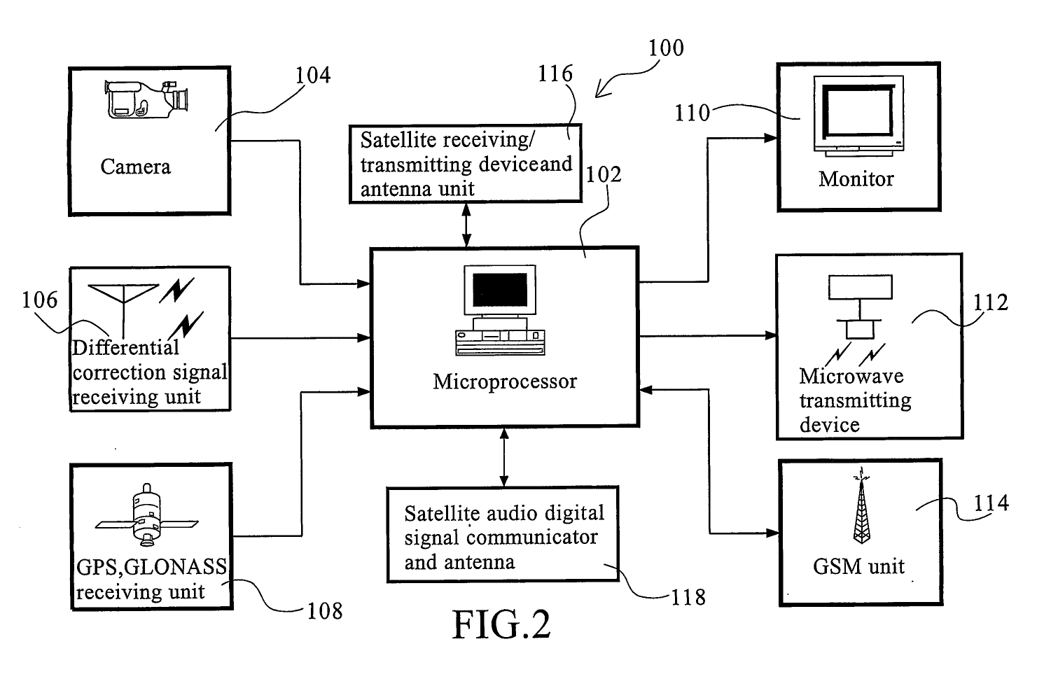

FIG. 2 is function block diagram, schematically illustrating an aircraft A/V and digital information transmitting system, according to a preferred embodiment of the invention. The aircraft A/V and digital information transmitting system 100 includes a microprocessor 102, a camera device 104, a differential correction signal sub-carrier receiving unit 106, a global positioning unit 108, such as a GPS sensor or a GLONASS sensor, a video monitoring unit 110, a microwave transmitting device 112, a satellite or GSM audio communication system 114, a satellite video receiving/transmitting device and antenna unit 116, and a satellite audio digital signal communicator and duplex antenna unit 118.

The microprocessor 102 connects to the other peripheral units and is used to process the input data and accordingly to control the connected peripheral units to proceed the automatic tracking function. The video device 104 takes the A/V information and passes the information to the microprocessor 102. The video device 104 can provide the image data and audio data. Generally, the video device 104 can be infrared, color, black-white, star-light, or synthetic aperture radar (SAR). Also and the number of the video device 104 can be one or multiple installed at the predetermined locations in the cabin or a proper location such that the outer surface of the aircraft or the geology structure of the ground can be taken. The number of the video devices and their locations can be chosen according to the actual design.

The video device 104 can also be controlled by the central control station system outside from the aircraft. The number of the video devices 104 can be more than 100 distributed on the whole aircraft and are selected to be turned on for action. Further still, according to the available channels, multiple video signals at different location can be simultaneously transmitted to the central control station system. Particularly, when an emergent event occurs on the aircraft, the invention allows the central control station system to actively control the video devices to monitor the actual scene.

The differential correction signal sub-carrier receiving unit 106 includes a receiving part and antenna part. When aircraft flies in the sky, its location information includes a latitude-longitude location information, and a flying height information. The flying height information is also an essential information. Particularly, when the geological structure is complicate, the height information is important. The differential correction signal sub-carrier receiving unit 106 can precisely correct the height of the aircraft. The precision can be up to 5 meters. The unit 106 can also correct the latitude-longitude location. The differential correction signal sub-carrier receiving unit 106 uses a differential GPS (DGPS) technology, wherein a reference signal is emitted from the ground base, and a differential analysis is performed to precisely obtain the height.

The global positioning unit 108 includes, for example, a GPS or a GLONASS, so as to sense the location of the aircraft in latitude and longitude. The data are input to the microprocessor 102.

The monitoring unit 110 is controlled by the microprocessor 102 for usual monitoring use in the aircraft.

The microwave transmitting unit 112, is controlled by the micro processor 102, so as to detect any information, including performing the down-link of the A/V and digital information to the aircraft automatic tracking and A/V system.

The GSM (global system for mobile telecommunication) audio and digital communicator 114 is coupled to the microprocessor 102 in bi-direction, so as to communicate with the ground. In addition, the GSM also receives an A/V control signal to select the desired video device 104 to be turned on for down-linking the A/V and digital information.

A satellite communication unit includes, for example, the video receiving and transmitting unit 116 and the satellite audio digital signal communicator and antenna unit 118. Since the invention can precisely track the aircraft, the satellite antenna on the aircraft can be precisely aligned to the satellite, thereby the A/V communication quality can be maintained. When the aircraft flies out of the detectable ranges of radar at the ground, this unit can replace the communication units 112 and 114 to serve as the transmission of A/V and digital signals. Alternatively, according to the actual communication condition, one communication measure can be switched as the communication measure. The satellite communication transmitting and receiving units 116, 118 are the auxiliary equipment, can be activated at anytime. Particularly, when the aircraft flies away from the land area, the unit can be turned on to continue the tracking function.

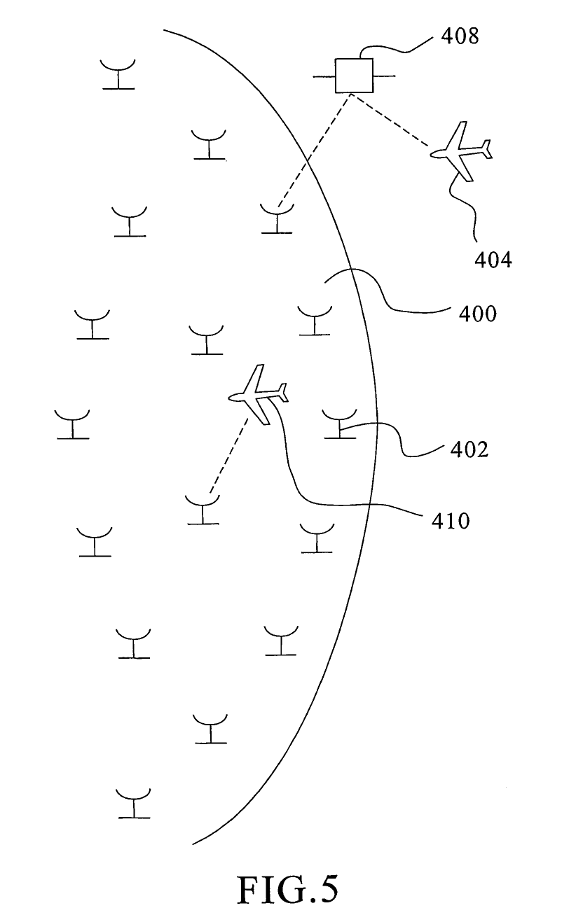

FIG. 5 is a drawing, schematically illustrating a global tracking mechanism for the global real-time transmission and control system of an A/V and digital information, according to a preferred embodiment of the invention. On the ground 400, a number of the tracking system bases form a tracking array 402. When the aircraft 410 flies within the detectable range of the tracking array 402, the tracking array 402 is responsible for tracking the aircraft 402. When the aircraft 404 flies out of the detectable range of the tracking array 402, such as flying to the outer sea. The video receiving and transmitting unit 116 and the satellite audio digital signal communicator and antenna unit 118 are employed for communicate with the ground through the satellite 408 on the specific track. The communication is bi-directional, so that the aircraft can be globally tracked with the A/V and digital transmission function in real-time.

For example, the commercial or passenger aircraft flies over the earth. When the passenger aircraft flies away from the land area, the satellite communication system is activated. When an accident or hijacking event occurs on the aircraft, the aircraft can be located at one place in the global scale. However, the control center can actively obtain the actual scene inside the cabin with respect to the video device. Since the number of passenger aircraft on the sky is large, each aircraft can be assigned with an identification code (ID). The control center can select the aircraft to identify its flying status.

The foregoing aircraft A/V and digital information transmitting system can be installed at the proper location. However, in order to avoid the affection on the flying safety, the hardware equipment can be, for example, installed together with other conventional electronic equipment or installed into the pods of the aircraft. The arrangement can be set according to the actual design. Antennas of the satellite communication unit 116 and 118 can be disposed at outer area of the aircraft and are aligned to the satellite.

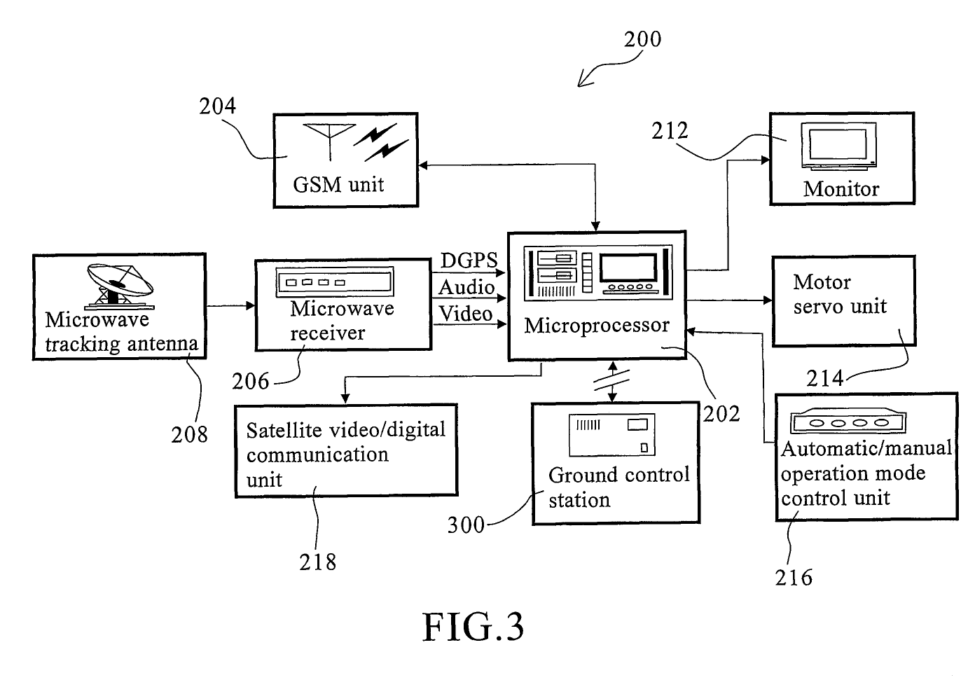

Continuously, FIG. 3 is a function block diagram, schematically illustrating an aircraft automatic tracking and A/V system, according to a preferred embodiment of the invention. In FIG. 3, the aircraft automatic tracking and A/V system 200 includes a microprocessor automatic-tracking servo controller 202, a satellite or GSM audio digital communicator 204, a microwave receiver 206, a microwave tracking antenna 208, a monitor 212, a servo motor unit 214, an automatic/hand operation mode control unit 216, and a Satellite video/digital communication unit 218.

The microprocessor automatic-tracking servo controller 202 is coupled to the other peripheral units and devices, so as to process the input data and accordingly control the peripheral units and devices. The microprocessor automatic-tracking servo controller 202 can also communicate with the central control station system to transmit data and any related data.

Since the invention can track the location of the aircraft, the satellite or GSM audio digital communicator 204 can communicate with the aircraft A/V and digital information transmitting system in bi-direction. In addition, when an emergent event occurs on the aircraft, or even such as hijacking event, the microprocessor automatic-tracking servo controller 202 can transmit the A/V control signal to the aircraft A/V and digital information transmitting system to select any desired video devices 104 on the aircraft. The desired video device 104 can be activated for observing the actual situation through the scene. If it is necessary, the information can be recorded.

The microwave receiver 206 and the microwave tracking antenna 208 form a single tracking unit. The microwave receiver 206 can receive the A/V and digital information and decode the video, audio, and DGPS data, and input the information to the microprocessor automatic-tracking servo controller 202. According to the location of the aircraft, the servo motor unit 214 can control the microwave tracking antenna 208, so as to align to the aircraft. Since the invention can precisely track the aircraft, the microwave tracking antenna 208 can be used for a bi-directional communication. The microwave tracking antenna 208 can associate with a satellite video/digital communication antenna 218 for bi-directional communication.

In FIG. 5, the aircraft automatic tracking and A/V system 200, 402 can be installed on the ground 400 to form a tracking array for tracking the aircraft in real-time. When the ground tracking array cannot sufficiently communicate with the aircraft, the satellite communication system, such as the satellite receiving unit and transmitting unit 116, 118 can be activated instead, so as to globally maintain the transmission of A/V and digital information.

The automatic/manual operation mode control unit 216 can include an automatic operation tracking mode and manual operation tracking mode. According to the actual need, one operation mode of them can be chosen for tracking the aircraft in real-time. Furthermore, the monitor 212 can be used for a usual safety monitor.

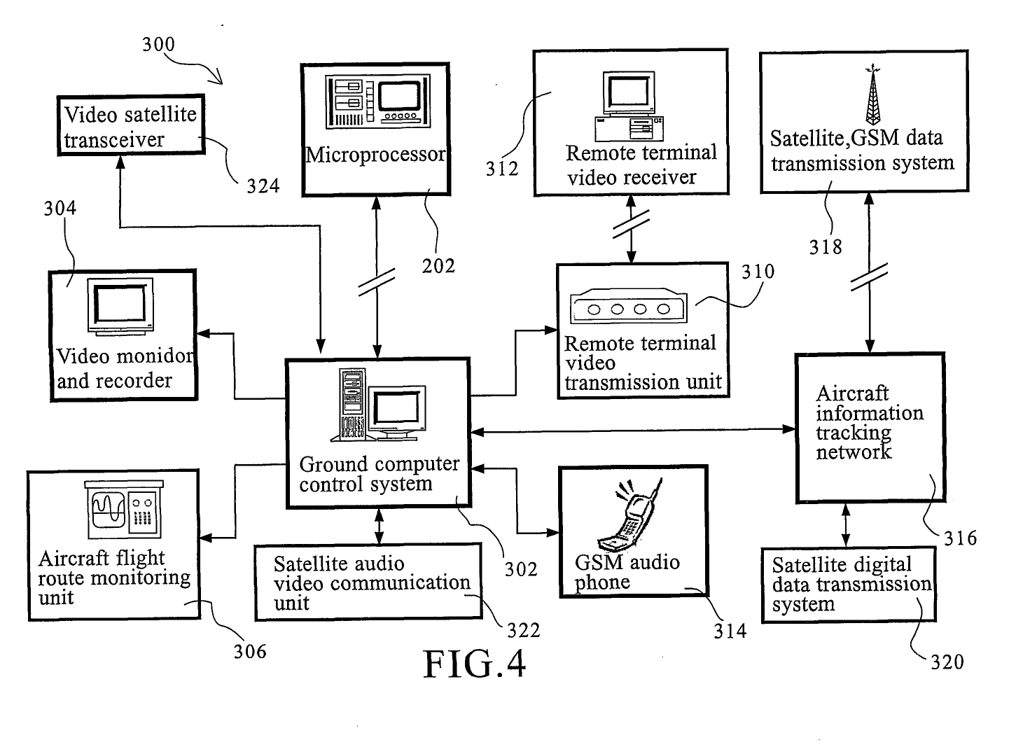

When the aircraft automatic tracking and A/V system receives the down-linked A/V and digital information, the A/V and digital information are also transmitted to the central control station system 300. FIG. 4 is a function block diagram, schematically illustrating a central control station system, according to the preferred embodiment of the invention. The central control station system includes a computer system 302, a monitor and recording unit 304, an aircraft flight route monitoring unit 306, a remote terminal video transmission unit 310, a satellite and GSM audio phone 314, an aircraft information tracking network 316, a satellite GSM data transmission system 318, a satellite digital data transmission system 320, a satellite A/V communication unit 322, and a satellite A/V transceiver 324.

The computer system 302 is connected with the foregoing other peripheral devices and can receive the information transmitted from the microprocessor automatic-tracking servo controller 202 (see FIG. 3), and then accordingly proceed control and process action.

The monitor and recording unit 304 is coupled to the computer system 302 to serve as the usual monitor.

The aircraft flight route monitoring unit 306 is used to recording the flight route of the aircraft.

A communication unit includes, for example, the remote terminal video transmission unit 310, which can transmit information to a remote terminal video receiver 312, whereby a communication with person at remote terminal is setup.

Audio communication unit includes, for example, the satellite GSM audio phone 314 can communicate and transmit data with other users through the satellite or GSM communication system.

The aircraft information tracking network 316 provides another communication route for communication the related persons through the network. However, if the A/V signal cannot be successfully received, the GSM system 318 can also be used to transmit data or the satellite digital data transmission system 320 is used to further transmit data out.

Furthermore, the computer system 320 is coupled with the satellite A/V communication unit 322 and the satellite A/V transceiver 324, so as to achieve the bi-directional communication through the satellite system. As shown in FIG. 5, when the aircraft flies far off the land, the forgoing communicating method can be used for tracking the aircraft and to achieve the global monitoring capability. When an emergent event occurs on the aircraft, the actual situation on the aircraft can be actively observed and realized.

According to the foregoing tracking system, it can be applied to a salvaging system with the features that the actual scene can be observed and realized by outside persons. However, the salvaging system can only proceed through the wireless communication system without including the rescuer backup. In order to further improve the salvaging effect in active manner, the invention further provide a rescuer backup measure.

For the current aviation technology, two aircraft can have solid contact in the air. The invention employs the foregoing wireless tracking system and introduces a rescuer transmission method. As previously described, the tracking system can be integrated into a rescuing aircraft. The rescuing aircraft can also carry rescuers and the needed rescuing matters for solving the emergent event.

A general aircraft, such as the passenger aircraft, has large volume. It allows to design with an emergent exit door. Since the rescuing aircraft by itself has tracking ability, the rescuer can be much easier to be transported into the aircraft.

In more specific case as an example, the rescuing aircraft usually is much smaller than the aircraft. The rescuing aircraft can land on the passenger aircraft through an affixing device, so that the rescuer can be transport into the passenger aircraft through the exit door.

Moreover, for example, when a hijacking event occurs on the aircraft, in order to prevent the invention from being destroyed, the system of the invention can be designed to be located at the place to which is not easily being reached. Or, it can be installed on the exterior part of the aircraft and is controlled by the rescuing aircraft.

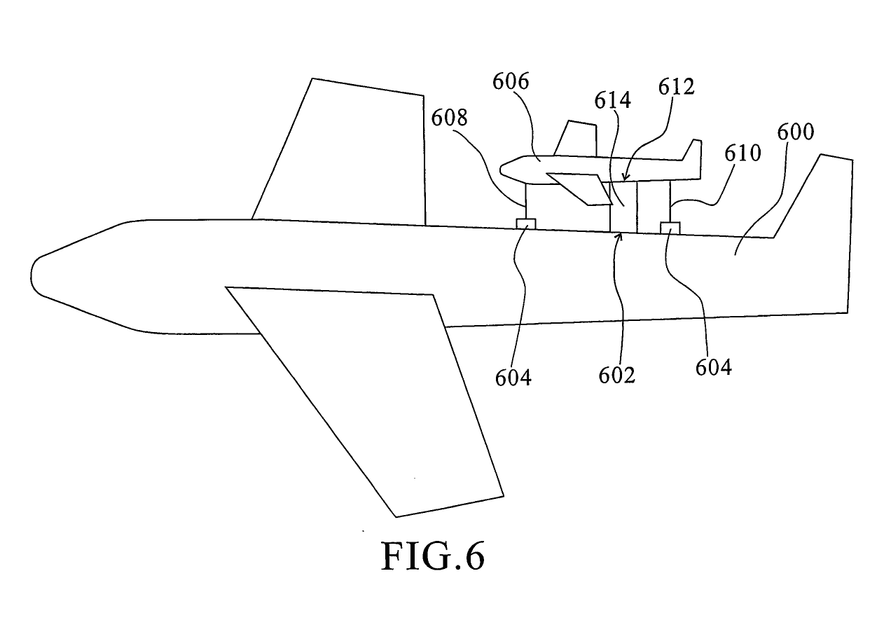

An example is provided as follows. FIG. 6 is a drawing, schematically illustrating a salvaging system, according to a preferred embodiment of the invention. In FIG. 6, if a real contact between the aircraft 600 and the rescuing aircraft 606 is intended. The rescuing aircraft 606 lands on the aircraft 600. The rescuing aircraft 606 is affixed on the aircraft 600 through the supporting structure 608 and 610, for example, by suction affixing manner. The rescuing aircraft is affixed on the aircraft 600 by the sufficient suction force. Preferably, the rescuing aircraft 606 lands on top of the aircraft 600. Since the body of the aircraft is a metallic hard material. In this situation, a buffer part 604, such as a soft pad, is also included at the contact place, so as to reduce the collision effect.

Since the rescuing aircraft 606 has active A/V monitoring capability, the situation inside the aircraft can be observed. The rescuing aircraft 606 can land on the aircraft 600 at the proper time. At this moment, the rescuing aircraft 606 can also known the environment condition in the cabin, such as pressure. Then, a passing route 614 is set to connect to the rescuing aircraft 606 between the exit door 602 of the aircraft 600 and the exit door 612 of the rescuing aircraft 606. The passing route 614 forms a close space, and the pressure is adjusted. Then the exit door 602 is open from the outside. In this situation, under the active control consideration, the door 602 is designed to open only from the outside. The aircraft 600 by itself cannot open the door 602.

In accordance with the landing of the rescuing aircraft 606, is a drawing, schematically illustrating the structure on the aircraft with respect to the salvaging system. For example, the exit door 602 is located on top of the aircraft 600. The affixing locations are arranged around the exit door 602 for landing the rescuing aircraft 606. The buffer part 604 is disposed on the affixing locations. Alternatively, the buffer part 604 can also be in combination with the supporting structure 608 on the rescuing aircraft in different design. When the rescuing aircraft 606 is affixed, the doors 602, 612 can be open, and the rescuer and any salvaging matter can be transported.

According to the invention, it includes several advantages as follows:

In the invention, a complete system with transmitting and receiving microwave video, audio, digital information is setup. The ground can automatically track the aircraft.

For the salvaging system In the invention, the tracking system for aircraft can be installed in a rescuing aircraft. The rescuing aircraft can also provide a transportation of rescuer. As a result, the event occurring on the aircraft can be effectively solved.

In the invention, the differential correction signal sub-carrier receiving unit 106 is installed on the aircraft, so as to precisely obtain the latitude, longitude, and flying height of the aircraft, which information is further transmitted to the ground.

In the invention, a GSM communication system is used to receive up-link signal to select and activate the video device on the aircraft, and transmit the A/V and data signal to the ground.

Since the invention can precisely track the aircraft, the satellite antenna on the aircraft can be precisely aligned to the satellite to up-link data. As a result, the video device can be controlled, and when an event occurs on the aircraft, the situation can be actively monitored.

The video device 104 of the invention can be controlled by the central control station for turning on. The number of the video devices can even up to 100 or more at the critical locations. Additionally, according to the available channels, multiple scenes can simultaneously transmitted to the central control station. Particularly, when an emergent event, such as hijacking, occurs on the aircraft, the invention allows the central control station to actively handle the situation.

In the invention, the aircraft automatic tracking and A/V system 200 and central control station system 300 can be integrated into a mobile transportation unit, such as on a train, ship or a rescuing aircraft. For example, when a hijacking occurs, the rescuing aircraft can be an air fighter or a specific plane and access the aircraft to deal with related matters. The rescuer can even be transported into the aircraft, such as a passenger aircraft, for solving the event together with the persons in the central control station.

In a general view on the whole system, the aircraft and the ground central control station can have bi-directional communication to automatically transmit the A/V and digital data, so as to achieve the tracking purpose.

The tracking system of the invention is suitable for use in various situations as follows:

1. Photo-reconnaissance on a natural disaster, such as earthquake, flood, fire, for monitoring the actual situation and transmitting the A/V and digital information to the central control station in real-time.

2. Real-time transmission of A/V and digital information for the environment protection, traffic condition, or cost guarding.

3. Real-time transmission of A/V and digital information for the 3-dimentional battle field.

Real-time transmission of A/V and digital information for a commercial aircraft, when a hijacking or an accident occurs on the aircraft.

5. Real-time transmission of A/V and digital information for surveying the ground area, a dummy-run, or a damage.

6. Real-time transmission of A/V and digital information for news report, such as a TV news instant report.

7. The automatic aircraft tracking system associating with the ground control station being applied to a radar tracking, an automatic weapon firing system, a video system with high magnified camera, or a mobile truck-mounted satellites-antenna automatic tracking system.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A global real-time transmission and control system of an audio/video (A/V) and digital information, suitable for use by a control side to track an aircraft, the global real-time transmission and control system comprising:
an aircraft A/V transmitting system, installed on the aircraft, and used to obtain an A/V and digital data information including a 3-dimensional position information, an audio information, or video information, wherein the A/V and digital data information can be down-linked and a video control signal transmitted from the control side can also be received for dynamically taking the A/V and digital data information;
a satellite transceiver unit, used to transmit the A/V and digital data information to the control side in real-time and receive the video control signal, wherein the satellite transceiver unit also provide an additional function to perform a bi-directional communication with the control side;
an aircraft automatic tracking and A/V system, installed on a base, used to receive the down-linked A/V and digital data information and track a position of the aircraft, also and transmit the A/V and digital data information; and
a central control station system, installed at the control side at a control center, used to receive a relative information transmitted from the aircraft automatic tracking and A/V system, and to dynamically control the aircraft A/V transmitting system to obtain the A/V and digital data information through the aircraft automatic tracking and A/V system,
wherein the aircraft automatic tracking and A/V system and the central control station system can be installed at predetermined locations or be integrated to be a mobile system.

2. The global real-time transmission and control system of claim 1, wherein the aircraft A/V transmitting system comprises:
a microprocessing unit, used to process a plurality of input signals, so as to control a plurality of peripheral units connected with the microprocessing unit, wherein the peripheral units comprises:
a surface positioning unit, used to at least precisely measure the position of the aircraft with respect to a ground surface;
a latitude, longitude, and height correction unit, used to further precisely measure the position of the aircraft by latitude, longitude, and height;
a video unit, used to at least take an A/V signal from the aircraft;
an A/V down-link unit, provide a first route for transmitting the A/V and digital data information to the control side; and
a bi-directional audio and digital communication unit, providing a second route for transmitting the A/V and digital data information to the control side and receiving the video control signal issued by the control side.

3. The global real-time transmission and control system of claim 2, wherein the video unit includes a video device that can be selected by the control side to take the A/V and digital data information.

4. The global real-time transmission and control system of claim 2, wherein the video unit includes a plurality of video devices distributed on the aircraft at predetermined locations and the video unit can have multiple video devices simultaneously taking the A/V and digital data information.

5. The global real-time transmission and control system of claim 2, wherein the latitude, longitude, and height correction unit includes a differential correction signal sub-carrier receiving unit to precisely correct the height of the aircraft.

6. The global real-time transmission and control system of claim 2, wherein the surface positioning unit comprises a GPS or a GLONASS for measuring the position of the aircraft.

7. The global real-time transmission and control system of claim 2, wherein the bi-directional audio and digital communication unit includes a GSM (global system for mobile telecommunication) or a satellite communication system for communicating with the control side.

8. The global real-time transmission and control system of claim 7, further comprising a satellite antenna device so as to perform the bi-directional communication through the GSM or the satellite communication system.

9. The global real-time transmission and control system of claim 2, wherein the A/V down-link unit comprises a microwave transmitting unit.

10. The global real-time transmission and control system of claim 1, wherein the aircraft automatic tracking and A/V system comprises:
a microprocessor automatic-tracking servo control unit, connected to a plurality of peripheral units to process a plurality of input signals, so as to according control the peripheral units, the peripheral units comprising:
a tracking unit, used to receive the A/V and digital data information transmitted from the aircraft A/V transmitting system;
an audio and digital bi-directional communicating unit, used to communicate with the aircraft A/V transmitting system;
a tracking operation mode controller, used to select one type of tracking operation mode; and
a mechanical servo unit, used to drive the tracking unit to track the aircraft.

11. The global real-time transmission and control system of claim 10, wherein the tracking unit comprises:
a microwave tracking antenna, to track the aircraft; and
a microwave receiver, to receive an output of the microwave tracking antenna, and to analyze out the A/V and digital data information into the 3-dimensional position, the audio signal or the video signal.

12. The global real-time transmission and control system of claim 11, wherein the mechanical servo unit comprise a motor servo control unit to drive the microwave antenna.

13. The global real-time transmission and control system of claim 10, wherein the tracking operation mode controller comprises a switch between an automatic operation mode and a hand operation mode.

14. The global real-time transmission and control system of claim 10, wherein the audio and digital bi-directional communicating unit comprises a GSM system.

15. The global real-time transmission and control system of claim 1, wherein the central control station system comprises:
a computer system, connected to the aircraft automatic tracking and A/V system and also connected to a plurality of peripheral units, the peripheral units comprising:
an outward communication unit, connected an external receiver for transmitting the A/V and digital data information;
an aircraft information tracking network; and
a recording unit, used to record the flight rout of the aircraft.

16. The global real-time transmission and control system of claim 15, wherein the outward communication unit comprises a remote terminal video transmission unit, to transmit the A/V and digital data information to the external receiver.

17. The global real-time transmission and control system of claim 15, wherein the outward communication unit comprises satellite and GSM audio system.

18. The global real-time transmission and control system of claim 15, wherein the aircraft information tracking network can communicate with an external user through a satellite or GSM system.

19. The global real-time transmission and control system of claim 1, wherein the aircraft A/V transmitting system is installed in a pod of the aircraft.

20. The global real-time transmission and control system of claim 1, wherein the satellite transceiver unit comprises a video and digital antenna and an audio and digital antenna.

21. A salvaging system with a global real-time transmission and control system, suitable for use by a rescuing aircraft to track and rescue a being-rescued aircraft, the salvaging system comprising:
a bi-directional automatic-tracking A/V and digital communicating and control system, installed between being-rescued aircraft and the rescuing aircraft, so as to allow the rescuing aircraft to automatically track being-rescued aircraft, and actively obtain an A/V and digital data information about an actual scene occurring at being-rescued aircraft; and
a transmission system, installed between being-rescued aircraft and the rescuing aircraft, such that the rescuing aircraft can transport at least a rescuer to being-rescued aircraft for proceeding a salvaging action.

22. The salvaging system of claim 21, wherein the transmission system comprises:
a first exit door, located at being-rescued aircraft;
a second exit door, located at the rescuing aircraft;
an affixing system, used to allow the rescuing aircraft to land on being-rescued aircraft at the predetermined position; and
a close-space passing route, used to connect being-rescued aircraft and the rescuing aircraft between the first exit door and the second exit door, whereby the rescuer can enter being-rescued aircraft, wherein an air pressure in the close-space passing route is adjusted to match the a pressure of the cabin.

23. The salvaging system of claim 22, wherein the affixing system comprises a buffering device, used to reduce collision effect when the rescuing aircraft lands on being-rescued aircraft.

24. The salvaging system of claim 22, wherein the affixing system used a suction force to affix the rescuing aircraft onto being-rescued aircraft.
